(19) United States
(12) Patent Application Publication
(10) Pub. No.: US 2005/0033767 A1
(43) Pub. Date: Feb. 10, 2005

(54) Computer-implemented system and method for resource caching and execution

(76) Inventors: Joel D. Kamentz, Efland, NC (US); James A. Adams, Cary, NC (US); Charles R. Main, Morrisville, NC (US)

Correspondence Address: John V. Biernacki;Jones Day, North Point, 901 Lakeside Avenue, Cleveland, OH, 44114, US

(21) Appl. No.: 10/633,921

(22) Filed: Aug. 4, 2003

(51) Int. Cl. G06F 17/00

(52) U.S. Cl. 707/104.1

(57) ABSTRACT

An adaptive resource caching and/or execution system includes a system processor in communication with a data store. The system processor receives an application program requiring one or more resources. The system processor identifies the required resources and one or more versions of each such resource that would be compatible with the received application program. The system processor locates a compatible version of each required resource on the data store. If a compatible version is not initially located, the system processor retrieves a compatible version from a suitable source such as a removable media or remote resource server. The system processor executes the application program in conjunction with the compatible versions of the required resources.

### TECHNICAL FIELD

The present invention is directed to systems and methods for handling computer-related resources. More specifically, without limitation, the present invention relates to resource caching and execution.

### BACKGROUND

Many software applications make use of external resources during local execution on a computer system. These external resources can include, without limitation, text file, graphics, video, or even additional software components. Traditionally, a distribution of a software application includes with it a copy of each required external resource. When the distribution is installed on a computer, the installation process typically places a copy of each required resource in a known location accessible by the computer.

With the increased popularity of the Internet and distributed computing, resources for applications distributed via a network might not be downloaded simultaneously with the application program. Instead, upon execution, the application program attempts to locate the desired resource and, if unavailable, attempts to retrieve it from a designated resource server. As with traditional distributions, the download process places the resource in a known location accessible by the computer executing the application. However, the download process may download a version of the program that overwrites an earlier version of the program. The newly downloaded version may be incompatible with another application, and may cause the other application to fail during execution. Many other issues may arise in such situations, such as the applications having to repeatedly download their own versions due to their respective versions being overwritten by another application.

### SUMMARY

In accordance with the teachings disclosed herein, a system and method are provided for selecting a resource for use during execution of a software application. At least a portion of the software application is received for local execution and wherein a resource is requested. One or more compatible versions of the resource are determined and used during execution of the software application. It is to be understood that both the foregoing general description and the following detailed description are exemplary and explanatory only and are not restrictive of the invention, as claimed.

### BRIEF DESCRIPTION OF THE DRAWINGS

FIGS. 1-3 are block diagrams of various computer and software components for use in adaptive resource caching and/or execution environments;

FIG. 4 is a flow chart depicting an exemplary resource caching and execution scenario;

FIG. 5 is a block diagram of class loaders;

FIG. 6 shows an example of a cache directory structure;

FIG. 7 is a graphical depiction of a Java architecture supporting the present adaptive resource caching and methods therefor; and

FIGS. 8 and 9 depict exemplary user views of the Java architecture shown in FIG. 7.

### DETAILED DESCRIPTION

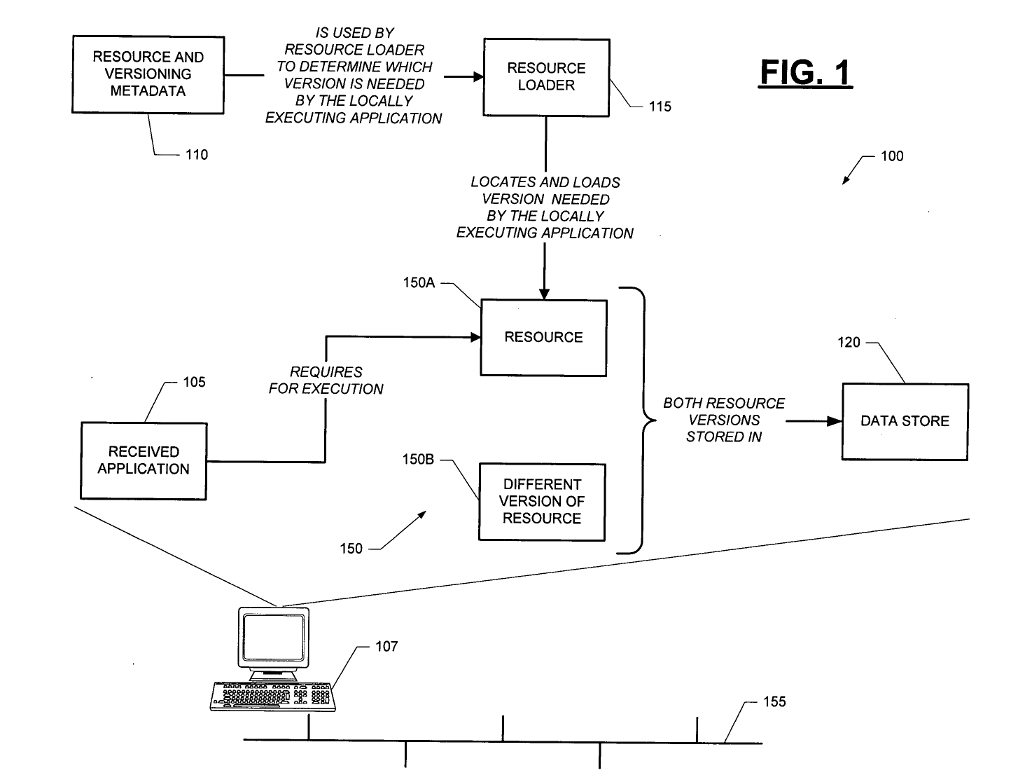

FIG. 1 depicts a system 100 that handles resources needed for execution of an application program 105 on a local computer 107. Although the system 100 may have multiple versions 150 of the resource stored on the local computer, the system 100 determines a compatible resource 150A that can be used by the application program 105. The determined resource 150A is then provided to the application program 105 so that it may be used during execution. If the resource is not located on the local computer 107, then various operations may be performed, such as issuing to a remote computer over a network 155 a request for the resource.

As an example, the application program (or a portion thereof) 105 is received for execution on the local computer 107. The application program 105 can be received from any suitable source including without limitation from the local computer's data store 120, other secondary or primary storage accessible by the local computer 107 or from a remote application server via an appropriate communication path such as computer network 155 (e.g., Internet, LAN, etc.). It should be understood that other types of communication paths may be used, such as, but not limited to, a telephone line (modem connection), direct peer-to-peer connection (e.g., serial bus, parallel bus, BLUETOOTH wireless, etc.), etc.

The received application 105 can in some instances begin execution prior to the locating and loading of required resources; in some such instances, partial application execution can be suspended one or more times pending locating and loading a required resource. In other instances, local execution may not be able to begin prior to locating required resources.

The one or more required resources and associated versioning information (meta-data) 110 are determined based upon the received application 105. A resource loader 115 such as provided through the local computer's operating system and/or run time environment can determine what version(s) of resources may be used by the application program 105. The resource loader 115 learns what resource(s) and resource version(s) are needed by the application program 105 by examining resource and versioning metadata 110. The resource and versioning metadata 110 may assume different forms. For example, the resource loader 115 can identify required resources by analyzing the received application program 105 or by consulting a resource directory using some indicator corresponding to the application program 105. In the latter approach, the directory could be implemented in a variety of ways including without limitation a flat file, a hash table, a database or combinations thereof. In some instances, the directory can be remotely accessed and/or retrieved upon identification of the required resource.

Similarly, versioning information can be determined through analysis of the received application 105 or by consulting the same directory as for resource identification or through a separate consultation and/or retrieval. As an illustration, a class can execute within the Java virtual machine (VM) and act as the resource loader 115.

The versioning metadata 110 can be as expressive as needed for the situation at hand. For instance, the metadata can define acceptable (or unacceptable) patterns of version data (typically in the form of version numbers or version release date). However, any metadata applying to specific resource instances (versions) may be used. The metadata might express inter-compatibility of resources within a set delivered to a client, or even compatibility of resources with the current execution environment. A Java implementation, for example, may use metadata which expresses “Java VM<->JAR compatibility.” Summarily, the metadata may be any information used to express the fitness or usability (and/or lack of fitness or usability) of resources and/or specific versions of a resource.

As noted above, many options exist for storing, deriving, inferring or otherwise generating the metadata. Metadata might be stored in or with the resources themselves, supplied by the requestor, supplied by an external metadata repository server or other indirect reference such as a URL, or any combination of the above. When this versioned resource technique is applied at different scales, the environment itself might lend itself to inductive or analytical generation of the necessary metadata. Such analytical generation can occur locally during application execution, or in the case of an application received from a remote server, the remote server could perform the analysis and provide the metadata concurrently with, or subsequent to, the served application. In some instances, creation, modification or compilation date of an application can be used to infer version metadata for specific resources; for example, version metadata for all resources associated with the application could include an inferred restriction requiring resource versions created prior to the application.

Multiple versions 150 of a resource may be stored in the local computer's data store 120. A resource loader 115 may utilize the data store 120 in different ways. For example, a resource loader 115 can examine a predefined area of the data store 120 for a particular version of the required resource. In some instances, version information for various resources can be inferred from the directory structure of the predefined area of the data store 120. Alternatively, a resource loader 115 can query a database portion of the data store 120 to determine if a compatible version of a required resource is available.

Similarly, a hash table or flat file could be searched to determine the presence or absence of a compatible version. In a Java environment, different implementations may be used, such as the one discussed in further detail below which uses a resource loader class to examine directory structure information to attempt to locate a required resource. It should be understood that the resource identification and loading process can be executed multiple times if multiple resources are required. Such multiple executions can occur in series or in parallel depending upon the desired implementation.

If multiple compatible versions are identified in the local data store 120, a particular version can be picked either at random or according to a particular deterministic approach. Some exemplary deterministic approaches include utilization of a previously loaded compatible resource; if available, selecting the newest available compatible resource, selecting the smallest sized available compatible resource and/or combinations of such approaches.

In some instances, when a required resource cannot be located, processing can proceed with retrieval of a compatible version of the required resource. The resource retrieval can be initiated in some implementations by a resource loader 115. The resource can be retrieved from any suitable source including without limitation a removable media, a resource server or a fixed media device accessible by the system processor. In a particular Java implementation, a resource loader class can initiate communication with a remote resource server and retrieve the resource, or an archive (e.g., JAR) containing the resource. The retrieved resource may then be stored in the data store 120.

Storage may occur in a manner conducive to subsequently locating the stored resource based upon versioning metadata. For instance, a hash value or relational attribute corresponding to desired versioning metadata could be used to initially store the resource so that it may be later located. In a particular Java implementation, the resources are stored in the data store 120 as a directory hierarchy indicating versioning metadata implicitly in the directory structure. If desired, the resource loader 115 itself can perform the storage functionality.

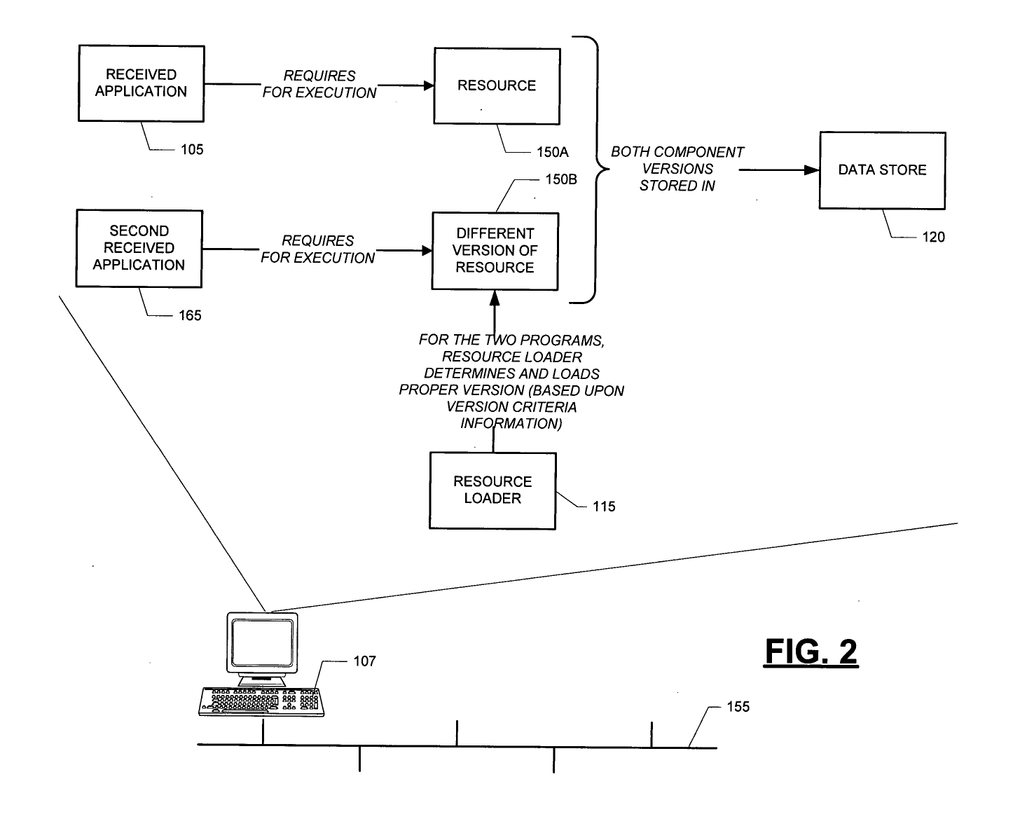

The stored resources are not limited in use to a single application program. Rather, multiple application programs requiring the same version of the same resource can use a resource stored in the local cache 120 without requiring a separate resource retrieval. Multiple applications may also require different versions of the same resource; if each such different version can be stored in the local cache 120, a separate resource retrieval need not occur. As an illustration, FIG. 2 depicts an example involving multiple applications (105, 165). A second received application program (or portion thereof) 165 is locally executing and requires for execution a different version 150B of the same resource required by the first received application 105. The resource loader 115 can perform the appropriate version determination and resource loading for the second application program 165 as described hereinabove. Both distinct versions can simultaneously coexist within the local data store 120.

It is noted that the specific versions of resources are determined at the time of the request, and therefore may change between clients or multiple instances or invocations of the same client. Different versions of the same resource may be used simultaneously. Also, a specific version of a resource may be shared between multiple clients.

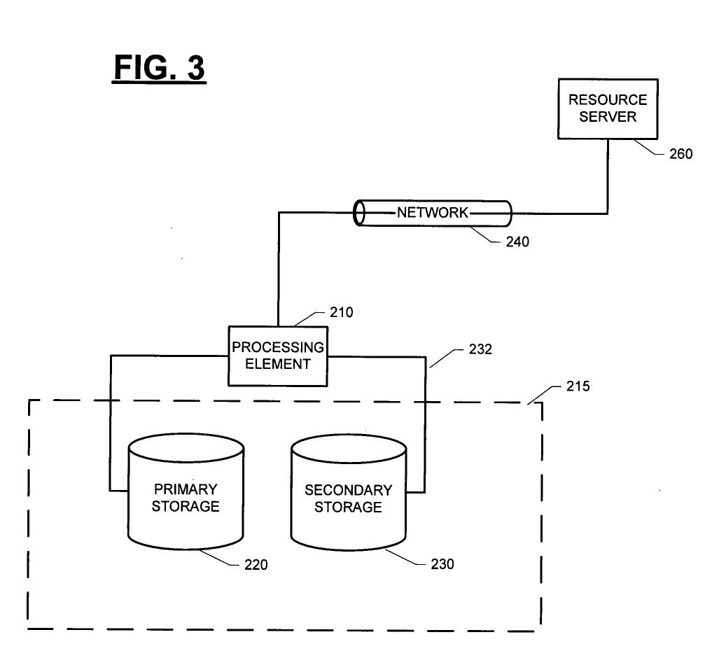

The resource handling system may be utilized in many different environments, such as the environment shown in FIG. 3. The environment may include a system processor potentially including multiple processing elements (e.g., processing element 210). The term processing element may refer to (1) a process running on a particular piece, or across particular pieces, of hardware, (2) a particular piece of hardware, or either (1) or (2) as the context allows. Each processing element may be supported by one or more general purpose processors such as Intel-compatible processor platforms including PENTIUM IV or CELERON (Intel Corp., Santa Clara, Calif.), UltraSPARC (Sun Microsystems, Palo Alto, Calif.) and/or Athlon (Advanced Micro Devices, Sunnyvale, Calif.) and/or one or more optimized local processors such as a digital signal processors (DSPs), application specific integrated circuits (ASICs) and/or field programmable gate arrays (FPGAs).

The depicted hardware components include computer storage 215 that could include a variety of primary 220 and secondary 230 storage elements. As an example, computer storage 215 could include RAM as part of the primary storage 220; the amount of RAM might typically range from 64 MB to 2 GB in each individual hardware device although these amounts could vary. The primary storage 220 may in some embodiments include other forms of memory such as cache memory, registers, non-volatile memory (e.g., FLASH, ROM, EPROM, etc.), etc. The primary storage 220 may communicate with the system processor, or particular elements thereof, in a standard manner or manners, including without limitation on chip communication path and/or serial and/or parallel bus pathways inter- and/or intra-board.

Computer storage 215 may also include secondary storage 230 containing single, multiple and/or varied servers and storage elements. It should be understood that the different information used in the adaptive resource selection and execution processes and systems may be logically or physically segregated within a single device serving as secondary storage 230 for the computer storage 215; multiple related data stores accessible through a unified management system, which together serve as the computer storage 215; or multiple independent data stores individually accessible through disparate management systems, which may in some embodiments be collectively viewed as the computer storage 215.

For example, computer storage 215 may use internal storage devices connected to the system processor 210. In embodiments where a single processing element 210 supports all of the adaptive resource selection and execution functionality, one or more local hard disk drives and/or one or more removable media drives may serve as the secondary storage of the computer storage 215 communicating with processing element 210 via a suitable direct connection 232 such as an IDE, USB or SCSI bus connection or through a network connection to locally accessible network connected storage (not shown), and a disk operating system executing on such a single processing element 210 may act as a data server receiving and servicing data requests.

The architecture of the secondary storage of the computer storage 215 may vary significantly in different environments. In several typical environments, database(s) can be used to store and manipulate the data such as resources and/or version metadata; in some such embodiments, one or more relational database management systems, such as DB2 (IBM, White Plains, N.Y.), SQL Server (Microsoft, Redmond, Wash.), ACCESS (Microsoft, Redmond, Wash.), ORACLE 8i (Oracle Corp., Redwood Shores, Calif.), Ingres (Computer Associates, Islandia, N.Y.), MySQL (MySQL AB, Sweden) or Adaptive Server Enterprise (Sybase Inc., Emeryville, Calif.), may be used in connection with a variety of storage devices/file servers that may include one or more standard magnetic and/or optical disk drives using any appropriate interface including, without limitation, IDE and SCSI. In some embodiments, a tape library such as Exabyte X80 (Exabyte Corporation, Boulder, Colo.), a storage attached network (SAN) solution such as available from (EMC, Inc., Hopkinton, Mass.), a network attached storage (NAS) solution such as a NetApp Filer 740 (Network Appliances, Sunnyvale, Calif.), or combinations thereof may be used. In other embodiments, the data store may use database systems with other architectures such as object-oriented, spatial, object-relational, network or hierarchical.

Instead of, or in addition to, those organization approaches discussed above, certain embodiments may use other storage implementations such as hash tables or flat files or combinations of such architectures. Such alternative approaches may use data servers other than database management systems such as (1) a hash table look-up server, procedure and/or process and/or (2) a flat file retrieval server, procedure and/or process. Further, the computer storage 215 may use a combination of any of such approaches in organizing its secondary storage architecture.

Resources for use with a locally executing application typically can be found in the computer storage 215. If a compatible version is not located in the computer storage 215, a compatible version of any needed resource is retrieved and stored in the computer storage 215. The retrieval of each resource can be from a variety of sources including without limitation a removable or fixed media device, accessible by the system processor, that is either part of, or separate from, the secondary storage of the computer storage 215 or a resource server in communication with the system processor via a suitable communication path. In the architecture of FIG. 3, resource server 260 connects to processing element 210 of the system processor via network 240; however, other communication channels could be used such as telephone (modem) connection or direct peer-to-peer wired or wireless connection.

In some instances, one or more resources can be obtained in an archive. As an example using a Java environment, one or more required resources, potentially along with non-required resources, can be packaged together in a JAR for distribution by a resource server 260.

The hardware components may each have an appropriate operating system such as WINDOWS/NT, WINDOWS 2000 or WINDOWS/XP Server (Microsoft, Redmond, Wash.), Solaris (Sun Microsystems, Palo Alto, Calif.), or LINUX (or other UNIX variant). A typical environment includes a WINDOWS/XP (or other WINDOWS family) operating system. Target client platforms such as wireless devices and/or PDAs may use an appropriate operating system such as Windows/CE, PalmOS, or other suitable mobile phone or PDA operating system. Resource servers often use a LINUX (or other UNIX variant) operating system.

Residing above the operating system, typical local execution may include a suitable runtime environment such as a Java Virtual Machine (Java VM) usable for standalone applications or within the context of an Internet browser for Java applet execution; a runtime environment need not be present in all possible environments. A typical resource server includes software to provide resources upon request from a local execution environment. In many environments, a Web server such as IIS (Microsoft, Redmond, Wash.) or Apache may act as the resource server 260. Needed resources can, however, be retrieved from alternate approaches such as direct access from a removable media, a database lookup, a hash table look-up or any combination of suitable approaches.

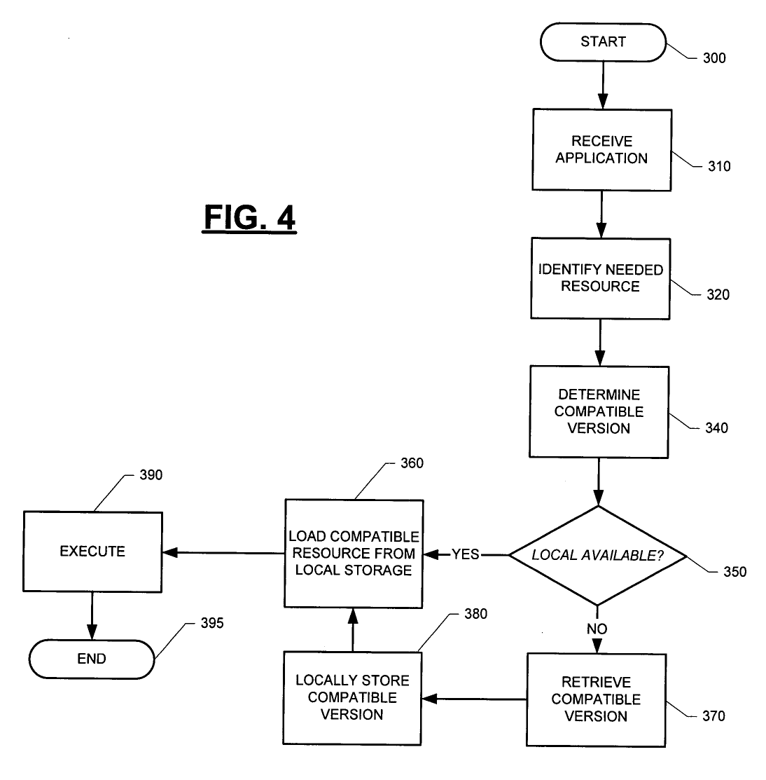

FIG. 4 depicts an operational scenario involving an adaptive resource system. Start indication block 300 indicates that an application is received at process 310. Process 320 identifies what resource or resources are needed for the application, and process 340 determines what version or versions of the resource may be used with the application.

Decision process 350 examines whether any acceptable resource version(s) are available on the local computer. If at least one is locally available, then process 360 loads the compatible resource from local storage for execution at process 390. Processing ends at least for this iteration at end block 395. In some instances, a compatible resource may already be loaded based upon a prior iteration or resulting from another executing application; in such instances process 390 may be skipped and the previously loaded compatible resource may be used. However, if decision process 350 determined that an acceptable resource version is not locally available, then process 370 retrieves a compatible version, such as from a remote server. Process 380 locally stores the retrieved resource so that process 360 may load it for execution at process 390. Processing ends at least for this iteration at end block 395.

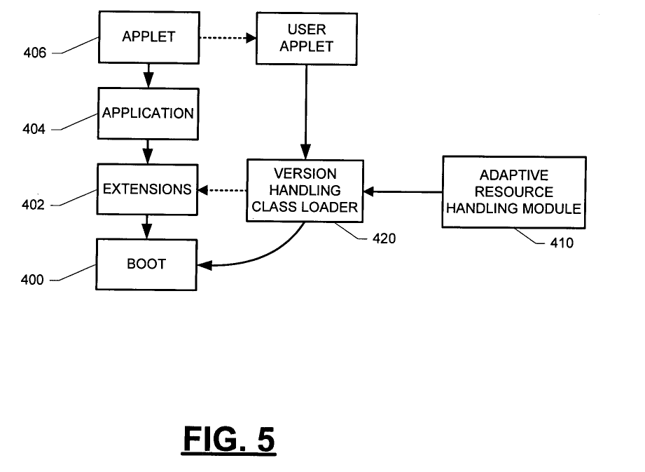

The following provides illustrative usages of adaptive resource caching in the context of a Java environment. Typically the Java environment would use multiple levels of class loaders as shown in FIG. 5. A first level is a boot ClassLoader 400 which provides core Java classes. These classes comprise the basis of the Java functionality. The next level of class loader is the extensions ClassLoader 402. This class loader is provided to allow for installable extensions to the Java system. The third level includes the Application ClassLoader 404. This class loader provides access to classes available through the CLASSPATH environment variable. An Applet ClassLoader 406 may be used to read classes from a remote machine and load them into the currently running VM.

Typically, an extensions directory provides a location for jar libraries. This directory is shared by applets and applications using the Java Runtime Environment (JRE). When the Java VM is started, it scans this directory and loads all the JARs in the extensions directory with the extensions ClassLoader 402. As a shared location, the extensions directory creates the potential for conflicts. The extensions ClassLoader 402 supports a flat, single-version view of resources. Conflict arises when a library is developed which is not compatible with previous versions. The end user has no idea that upgrading a JAR in order to run a new applet and/or application might break older applets and/or applications which they regularly use. Once this has occurred, a default mechanism is not automatically provided to correct the situation.

An adaptive resource handling module 410 provides a version handling class loader 420 that can handle multiple versions of a resource. The class loader 420 is provided as a replacement to the extensions ClassLoader 402 or as an enhancement thereto. The module 410 replaces the extensions directory with a database/cache which can hold multiple versions of a JAR concurrently. An implementation of such a module may include version handling ClassLoaders which do not use the extensions ClassLoader, but instead load specific versions of JARs in the database and which also load content from the regular extensions directory (the directory typically accessible by the standard extensions ClassLoader). In some embodiments, the database can be located under the user's home directory, or the user's home directory may contain a link to a customized database location. In this way, upgrading to a new version of Java does not break existing applications due to missing libraries nor requires applets to re-download JARs.

The versioned JAR cache may be a database capable of storing multiple versions of a resource and its associated metadata. In a particular Java implementation, a specific directory and file structure within the local computer using the underlying file system serves as the cache for resources.

The system described herein provides reasonable locking between processes and threads, speed, and reasonable storage efficiency. (The size of metadata is small compared to the size of jar resource instances.) Other functionality may be provided, such as the system also providing the ability to track the most recent usage time for a stored JAR, or allowing for an implementation to be written completely in Java and not requiring native code.

It is noted that the current Java convention is to declare version metadata for a JAR within the JAR's manifest file. However, not all JARs do this, and current Java standards do not support permanent installation of such JARs. An implementation of the adaptive resource caching and/or execution system can support JARs without version metadata by using file size, 32-bit CRC value, other suitable file attributes and/or combinations thereof as implicit metadata.

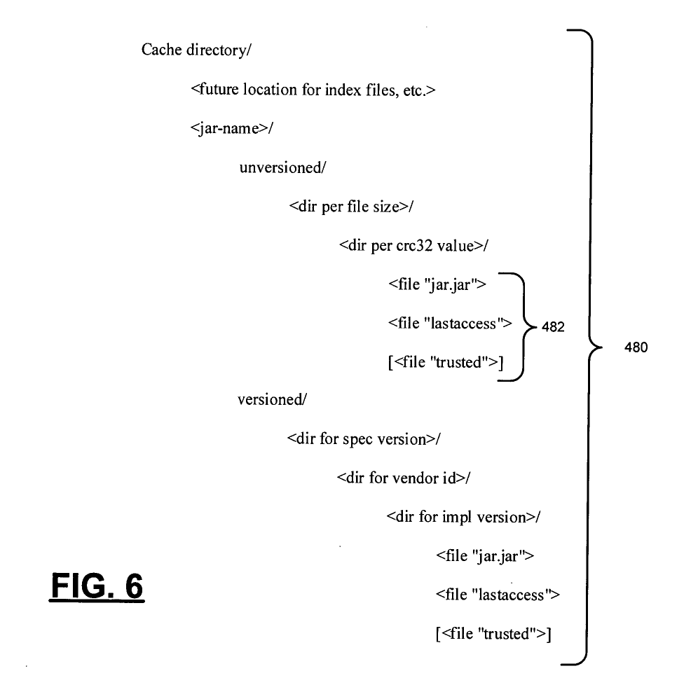

FIG. 6 shows at 480 an exemplary directory structure that creates a subdirectory for each resource (JAR) by name. A resource loader class may examine the directory structure information to attempt to locate a required resource. The directory structure 480 includes additional subdirectories of each JAR directory which express versioning metadata. Leaf directories 482 hold the resource data (original jar file content), additional metadata (trusted marker) and cache management data (last time used). This directory structure provides a unique one-to-one mapping between a set of versioning metadata and the relative path of a JAR's original contents within the cache directory structure.

The lastaccess data file can be used both for inter-process locking as well as tracking the last accessed time. When adding a JAR to the cache, the relative path is calculated from metadata and an atomic create of the lastaccess file is attempted. The remaining data files are created only if the lastaccess file is successfully created. This provides a measure of inter-process locking. Because there is a one-to-one mapping between version metadata and the relative path, there is not a need to upgrade or replace jar content within the cache. Thus, additional locking may be optionally used or even disregarded. A jar is marked as trusted code by creating a file named “trusted” in the content directory.

When a JAR is supplied to a client, the JAR cache opens the lastaccess file and replaces its current contents by writing a byte. This updates the last modified time of the lastaccess file. The last modified time of the lastaccess file can be queried from Java and serves as the last access time of the JAR contents (the jar.jar file).

In some embodiments, the local data store can include cache management functionality. Cache management functionality can include, without limitation, cache maximum size constraints. In some such embodiments implemented according to the approach described above, such size constraints can be achieved through use of the lastaccess file and a pruning function removing the least recently used resource. As will be understood by those skilled in the art, alternative approaches to cache size constraint maintenance and additional cache management functionality can be incorporated in the context of the present invention.

The default Java security mechanisms and specifications provide the ability to distinguish trusted and untrusted code based on signatures. While libraries of both types may be downloaded to a client machine, they are cached and loaded very differently.

Theoretically, only trusted code would ever be installed in the extensions directory. Applets may cause a jar to be downloaded, but it is only placed in the extensions directory if it is signed and the user trusts the signature. Other applications (not necessarily written in Java) running on the client machine could copy jars to the extensions directory, but presumably if such an application is able to access the file system in that manner, it is trusted by the user and will only install trusted code.

The default Java implementation behavior is to permanently cache trusted jars in the extensions directory (and also to implicitly trust anything in the extensions directory) and temporarily cache everything else. The content in the extensions directory is searched prior to caches of untrusted code, and the classes are loaded in separate ClassLoaders. With the standard ClassLoader hierarchy, this has the side-effect that code in an applet's untrusted libraries is not visible to the applet's trusted code libraries loaded by the extensions ClassLoader.

Optionally, untrusted code may be required to be downloaded and cached, and, unlike the normal provisions for untrusted code, these libraries may be cached long-term. To accomplish this, the versioned jar cache stores the trust status of each jar (initially based upon jar signing and user input). As an example, the existing Java 2TM security architecture may be used in such a way that untrusted library code in the versioned cache gains no special privileges (even when invoked by signed and trusted applets). This provides the ability to load both trusted and untrusted code in the same ClassLoader, thereby allowing library visibility.

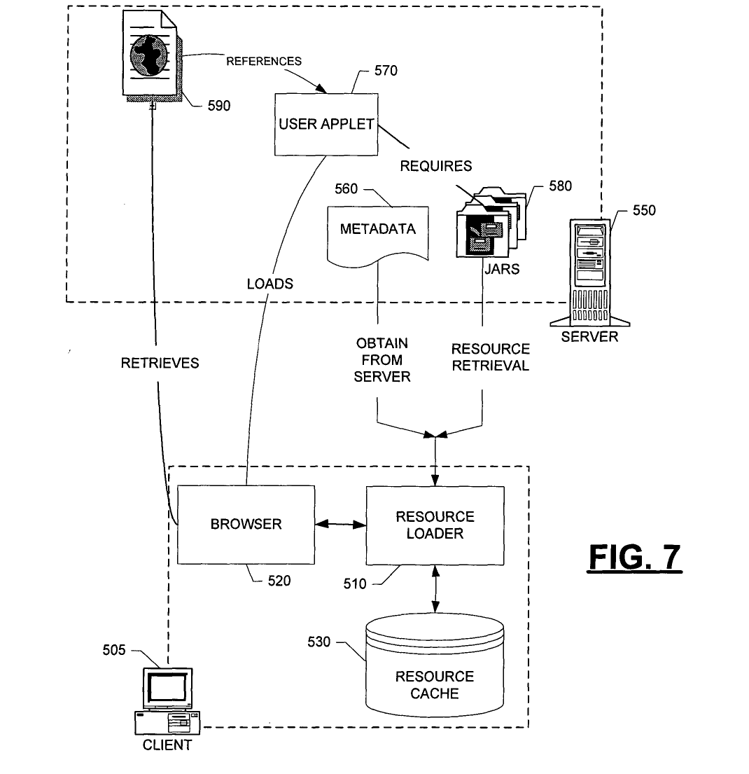

FIGS. 7-9 describe additional example scenarios of adaptive resource systems. As an overview for the scenario shown in FIG. 7, a user initiates a Web browser and enters the URL for a page containing a Java applet. In this example, the Java applet requires three resources for execution. The first resource (A) must be a version greater the 3.2. The second resource (B) cannot be versions 4 or higher. The third resource (C) must exclusively be the version distributed in December 2002. The version handling class loader looks for a version of each required resource in the versioned cache. For any resource not initially found, the version handling class loader connects to a remote server and attempts to download the required resource(s). Each downloaded resource is saved to the versioned cache using the above described directory structure. The resources are loaded and the applet executes (or continues its execution).

More specifically, the example of FIG. 7 makes uses of a Java applet 570 requiring resources from one or more JARs 580 that are referenced by a Web page 590 from a server 550. However, it should be noted that the applet 570 and resources 580 need not be stored on the same server together nor on the same server as the Web page 590. Further, the relationships and resource usage would apply to an application rather than the depicted applet 570 embedded within Web page 590.

In the depicted architecture, client computer 505 executes a Web browser application 520 and requests Web page 590 from server 550. The Java environment used by the browser 520, or alternatively enhanced through instructions from Web page 590, includes the resource loader 510. Web page 590 references applet 570; a determination is made as to whether the applet 570 requires any resources 580 based upon metadata 560 obtained from server 550 (in the depicted implementation). The resource loader 510 determines if compatible resources are available in the resource cache 530 and, if so, loads them. If not present, the resource loader 510 obtains the resources from server 550 and stores them in the resource cache 530.

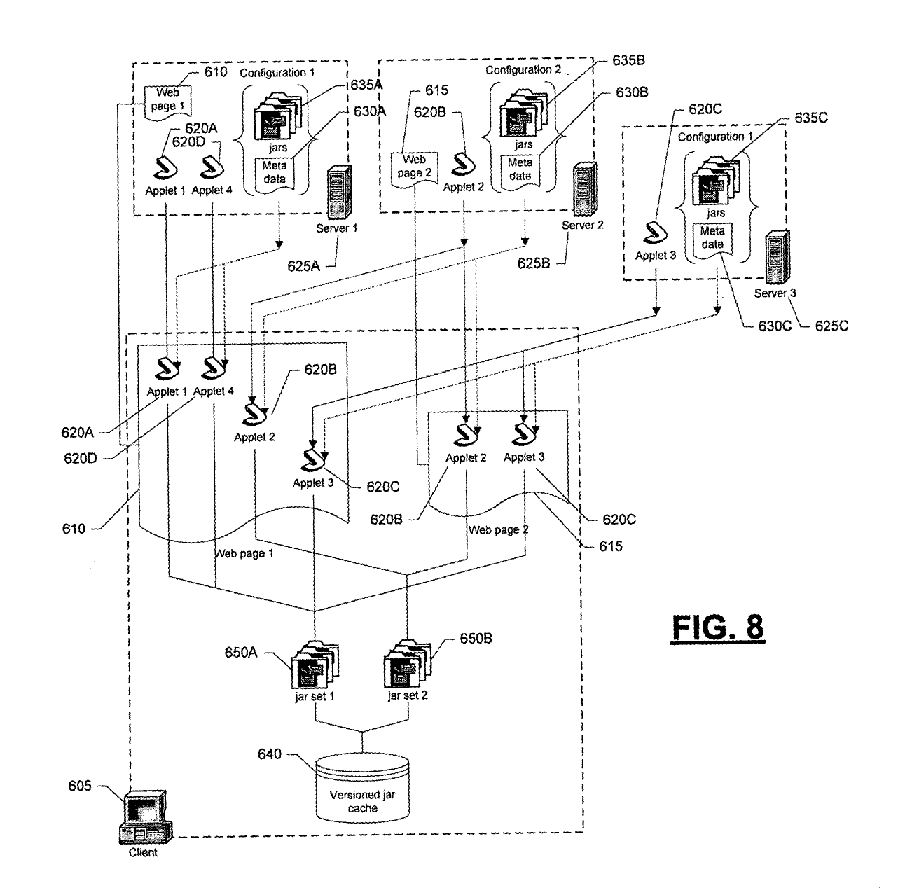

As an overview for the scenario of FIG. 8, a Java application executes and requires two resources: a first resource (B) and a second resource (D). The versioning metadata specifies a restriction that the first resource must be a version greater than 3 and specifies no restriction on the second resource.

More specifically, two Web pages 610, 615 are requested by a user through a client computer 605. The first Web page 610 resides on server 625A and references four applets 620A, 620B, 620C and 620D. The second Web page 615 resides on server 625B and references two applets 620B, 620C. Two applets 620A, 620D reside on server 625A along with metadata source 630A and a JAR repository 635A containing JARs that include required resources. The metadata source 630A contains metadata associated with the applets residing on server 625A, and the JAR repository 635A includes JARs containing required resources associated with the applets residing on server 625A. Under other implementations, the associated metadata and/or JARs could be stored on a different server (e.g., 625B, 625C, etc.). Another applet 620B resides on a separate server 625B; under the depicted implementation, metadata for this applet and JARs including required resources for this applet also reside on this server 625B in metadata repository 630B and JAR repository 635B. The last applet 620C resides on a third server 625C; as before, the associated metadata and JARs also reside on this server 625C in appropriate repositories 630C, 635C.

When the user requests the first Web page 610 from server 625 via an executing browser the Web page is downloaded to client computer 605. Referenced applets 620A-D are also downloaded to client computer 605. Required resources needed by these applets are determined, along with compatibility information for each such resource, based upon metadata from repositories 630A-C from servers 625A-C. For any resources not already located in the resource cache (versioned JAR cache) 640, JAR set 650A containing JARs that include the needed resources are retrieved from the appropriate JAR repositories 630A-C from the appropriate servers 625A-C and stored in the cache 640. The applets 620A-D can execute locally using compatible resources stored in the cache 640.

Similarly, when a user requests the second Web page 615 from server 625B, referenced applets 620B-C are downloaded from the appropriate servers 625B-C. Required resources and compatible versions of such are determined from metadata in repositories 630B-C. Because in this example the first page 610 was already accessed, compatible resources already exist in the resource cache 640, and local execution of the applets 620B-C can occur without further retrieval required. If the first page had not been previously accessed, required resources not already present would be retrieved in a set of one or more JARs 650B from JAR repositories 635B-C stored on server 625B-C. and stored in the resource cache 640. Local execution can then proceed.

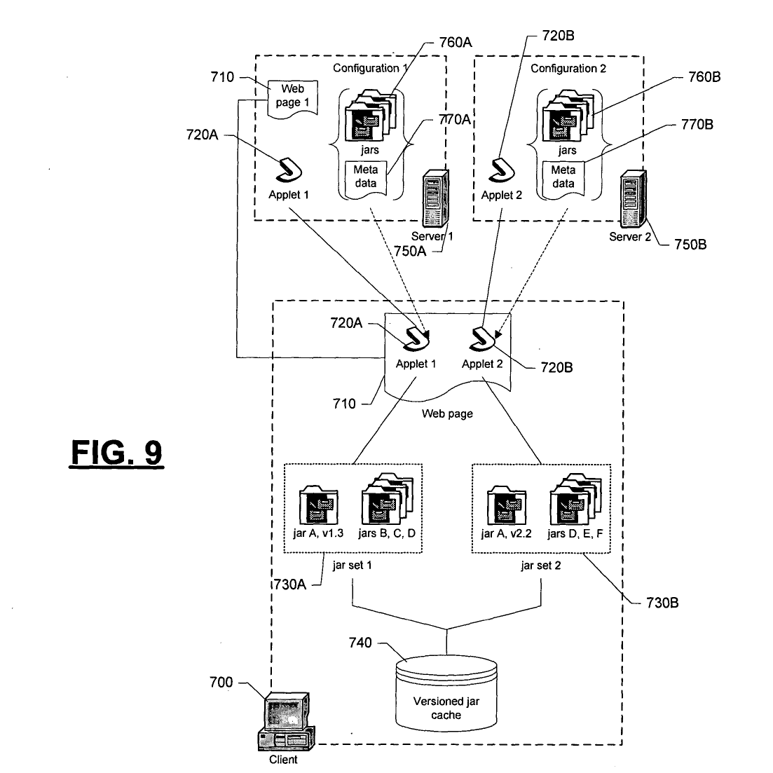

FIG. 9 depicts a user view of the retrieval of a single Web page 710 referencing two applets 720A, 720B. The user executes a browser application on client computer 700 that requests the Web page 710 from a server computer 750A. The referenced applets 720A, 720B are retrieved respectively from server computers 750A and 750B. Metadata in the repositories 770A, 770B on these server computers are consulted in connection with information related to the applets themselves to determine required resources along with compatibility information regarding such resources. From the metadata, a determination is made that applet 720A requires resources from JAR set 730A to execute and that applet 720B requires resources from JAR set 730B to execute. As depicted, both applets require resources from JARs A and D to execute. For JAR D, no compatibility restriction has been indicated; however, for JAR A, applet 720A requires version 1.3 while applet 720B requires version 2.2. If the required JARs are not found in cache 740, these JARs (or appropriate versions of the same JAR) are downloaded and stored therein. Once the requisite resources are in the cache 740. The applets 720A, 720B within the retrieved Web page 710 can locally execute.

While examples have been used to disclose the invention, including the best mode, and also to enable any person skilled in the art to make and use the invention, the patentable scope of the invention is defined by the claims, and may include other examples that occur to those skilled in the art. For example, the exemplary systems and methods herein may make reference to specific implementation details existing in a Java environment; however, these references do not limit the disclosed systems and methods to such an environment. Rather, other environments, whether according to an object-oriented, functional, or other paradigm, are specifically contemplated.

As another example, the disclosed systems and methods may be stored as computer executable instructions in and/or on any suitable combination of computer-readable media and/or transmitted in part, or in whole, via a suitable communication channels such as a network, direct parallel or serial connection or a telephone line using one or more modems.

The computer components, software modules, functions and data structures described herein may be connected directly or indirectly to each other in order to allow the flow of data needed for their operations. A module may be a unit of code that performs a software operation, and can be implemented for example as a subroutine unit of code, or as a software function unit of code, or as an object (as in an object-oriented paradigm), or as an applet, or in a computer script language, or as another type of computer code.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context clearly dictates otherwise; the phrase “exclusive or” may be used to indicate situation where only the disjunctive meaning may apply.

1. A method for selecting a resource for use during execution of a software application, the method comprising the steps of:
(a) receiving at least a portion of a software application for local execution;
(b) determining a resource to be used during local execution of the received software application portion;
(c) determining a set of one or more compatible versions of the determined resource for use with the received portion; and
(d) locating a compatible version from the determined set for local execution in conjunction with the received portion from a data store capable of storing a plurality of versions of one or more resources.

2. The method of claim 1, wherein the step of locating the compatible version for local execution comprises the steps of:
(i) searching the local data store for one or more versions of the determined resource;
(ii) identifying the compatible version from the one or more versions resulting from searching the data store.

3. The method of claim 2, wherein the step of locating the compatible version for local execution further comprises the step of (iii) retrieving the compatible version from a resource server and (iv) storing the retrieved compatible version in the data store, if the one or more versions resulting from the search does not include the determined compatible version.

4. The method of claim 3, wherein the step of storing the retrieved compatible version comprises the steps of:
(A) determining a storage location in the data store based upon metadata associated with the retrieved compatible version; and
(B) storing the retrieved compatible version in the determined storage location.

5. The method of claim 1, and further comprising the step of (e) locally executing the received portion of the software application in conjunction with the located compatible version.

6. The method of claim 1, wherein the step of determining the resource required for local execution comprises the steps of:
(i) accessing a configuration file based upon the received portion; and
(ii) retrieving identification information indicative of the resource from the accessed configuration file.

7. The method of claim 6, wherein the step of determining the resource required for local execution further comprises the step of (iii) receiving the configuration file from a remote server.

8. The method of claim 7, wherein the step of determining the resource required for local execution further comprises the step of (iv) requesting the configuration file from the remote server.

9. The method of claim 6, wherein the step of determining the resource required for local execution further comprises the step of (iii) updating the configuration file.

10. The method of claim 6, wherein the configuration file stores information indicative of at least one resource required for local execution associated with each of a plurality of potential received portions of one or more software applications.

11. The method of claim 6, wherein the configuration file stores information indicative of a plurality of resources.

12. The method of claim 1, wherein the step of determining the resource required for local execution comprises the steps of:
(i) analyzing the received software application portion for information indicative of the resource; and
(ii) identifying the resource based upon the information indicative of the resource.

13. The method of claim 1, wherein the step of determining the resource required for location execution comprises the steps of:
(i) requesting information indicative of the resource from a server computer associated with the received software application portion; and
(ii) identifying the resource based upon the information indicative of the resource.

14. The method of claim 1, and further comprising the step of (e) repeating steps (b) through (d) with respect to one or more additional required resources.

15. The method of claim 14, wherein the repetition step continues until all required resources for the received application portion have been determined.

16. The method of claim 1, wherein steps (b) through (d) execute a plurality of times in parallel with respect to a plurality of required resources.

17. A method of distributing executable code to select a resource for use during local execution of a software application, the method comprising the steps of providing an interface to a user that upon submission to a software distribution server causes the distribution server to transmit a plurality of executable instructions that upon execution by a system processor cause the system processor to perform the method of claim 1.

18. One or more computer readable media storing instructions that upon execution by a system processor cause the system processor to select a resource for use during local execution of a software application by performing the steps comprising of:
(a) receiving at least a portion of a software application for local execution;
(b) determining a resource required for local execution from the received software application portion;
(c) determining a set of one or more compatible versions of the determined resource for use with the received portion based upon the received portion;
(d) locating a compatible version from the determined set for local execution in conjunction with the received portion from a data store capable of storing a plurality of versions of one or more resources; and
(e) if locating the compatible version initially fails because the compatible version is not stored in the data store:
(i) retrieving the compatible version from a resource server; and
(ii) storing the retrieved compatible version in the data store by performing the steps comprising of:
(A) determining a storage location in the data store based upon metadata associated with the retrieved compatible version; and
(B) storing the retrieved compatible version in the determined storage location.

19. The media of claim 18, and storing further instructions that upon execution by a system processor cause the system processor to perform the additional step comprising of (f) repeating steps (b) to (e) with respect to a plurality of resources required for execution by the received software application portion.

20. A system to select a resource for use during local execution of a software application, the system comprising:
(a) receiving means for receiving at least a portion of a software application;
(b) resource requirement means for determining one or more resources required for local execution of the received software application portion and for determining a set of one or more resource versions compatible with the received software application portion for each determined required resource;
(c) resource storage means for storing a plurality of versions of at least one resource;
(d) resource location means for identifying in the resource storage means a compatible version of each determined required resource from the resource requirement means based on the set of one or more resource versions for each determined required resource and for retrieving the compatible version for each determined required resource for which no compatible version was present in the resource storage means during initial identification and identifying the retrieved compatible version for each such required resource; and
(e) resource loading means to load one or more resources located by the resource location means for local execution in conjunction with the received software application portion; and
(f) processing means for executing the received software application portion in conjunction with the one or more loaded resources loaded by the resource loading means.

21. A system to select a resource for use during local execution of a software application, the system comprising:
(a) a data store capable of storing application software and one or more versions of one or more resources for local execution in connection with the application software;
(b) a system processor in communication with the data store, wherein the system processor comprises one or more processing elements and wherein the one or more processing elements are programmed or adapted to:
(i) receive at least a portion of a software application for local execution;
(ii) determine a resource required for local execution from the received software application portion and a set of one or more compatible versions of the resource for use with the received portion;
(iii) search the data store for a located compatible version from the determined set;
(iv) retrieve and store in the data store a member of the determined set as the located compatible version if no member of the determined set is found in the data store from the search; and
(v) execute the received software application portion locally in conjunction with the located compatible version.
